(19) United States
(12) Patent Application Publication
(10) Pub. No.: US 2009/0284461 A1
(43) Pub. Date: Nov. 19, 2009

(54) METHOD FOR DISPLAYING IMAGE

(75) Inventors: Ching-Fu Hsu, Taichung County (TW); Chih-Chang Lai, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/468,034

(22) Filed: May 18, 2009

(30) Foreign Application Priority Data
May 19, 2008 (TW) 97118371

(51) Int. Cl. G09G 3/36; G06K 9/38

(52) U.S. Cl. 345/102; 382/172

(57) ABSTRACT

An image display method for a display apparatus is provided. The display apparatus has a light source module for providing a light source. An original image including a plurality of original pixels is provided, wherein each original pixel is represented by a plurality of first gray levels. A histogram is established according to the first gray levels. An adjustment factor is established according to the histogram, and the brightness of the light source is adjusted according to the adjustment factor. A brightness factor is established, and the original pixels are transformed into a plurality of output pixels according to the brightness factor such that the display apparatus displays an output image according to the output pixels. Each of the output pixels is represented by a plurality of second gray levels, and each of the second gray levels is the product of the first gray level and the corresponding brightness factor.

### CROSS-REFERENCE TO RELATED APPLICATION

This application claims the priority benefit of Taiwan application serial no. 97118371, filed on May 19, 2008. The entirety of the above-mentioned patent application is hereby incorporated by reference herein and made a part of specification.

### BACKGROUND OF THE INVENTION

1. Field of the Invention

The present invention generally relates to an image display method, and more particularly, to an image display method for a display apparatus having a light source module.

2. Description of Related Art

Along with the advancement of photoelectricity and semiconductor techniques, flat panel displays, such as liquid crystal display (LCD), have been quickly developed and broadly applied in different electronic products. LCD has become the mainstream product in the display market due to its characteristics such as low power consumption, no radiation, and high space efficiency.

A LCD includes a LCD panel and a light source module. The LCD panel itself does not emit light, and accordingly the light source module has to be disposed below the LCD panel to provide a planar light source such that the LCD can display images. The light source module has to provide a light source constantly once the LCD is turned on therefore the light module is the most power-consuming element in the LCD. Generally speaking, the light source module consumes about 70% of the electricity consumed by the entire LCD.

Accordingly, the designs of many LCD-related electronic products are focused on the reduction of electricity consumption of the light source modules thereof. Different operation modes usually set in an LCD is common design. The light source module provides a planar light source of different intensity in different operation mode. Thus, a user can switch to different operation mode in different operation environment. For example, the intensity of the planar light source is reduced when an electronic device is in a standby mode so that less electricity is consumed by the light source module.

However, in the conventional method described above, even though the electricity consumed by an LCD can be reduced by adjusting the intensity of the planar light source in different operation modes, the images displayed by the LCD may be distorted. Thus, in some electronic product designs, the intensity of the planar light source is further adjusted according to the characteristic of the image content displayed by the LCD. However, the change in intensity of the planar light source provided by the light source module may still cause some images to lose their original contrasts and accordingly be distorted. Thereby, the conventional technique does not allow an LCD to present images correctly when it focuses on the reduction of electricity consumption of the light source module.

### SUMMARY OF THE INVENTION

Accordingly, the present invention is directed to an image display method, wherein the problem of image distortion caused by reduced intensity of a light source provided by a light source module is resolved.

The present invention provides an image display method for a display apparatus, wherein the display apparatus has a light source module for providing a light source when the display apparatus displays images. First, an original image composed of a plurality of original pixels is provided, wherein each of the original pixels includes a plurality of first gray levels. A histogram is established according to the first gray levels and the number thereof. One of the first gray levels is selected as a characteristic gray level (apl) from the histogram, and an adjustment factor (BACKDIM) is established according to a maximum gray level (aplₘₐₓ) of the display apparatus and the characteristic gray level (apl). After that, the brightness of the light source provided by the light source module is adjusted according to the adjustment factor (BACKDIM). The first gray levels of each of the original pixels are transformed into a first brightness value, and the first brightness value are transformed into a second brightness value to obtain a brightness factor, wherein the brightness factor is the ratio of the second brightness value to the first brightness value. The original pixels are transformed into a plurality of output pixels according to the brightness factor such that the display apparatus displays an output image according to the output pixels with the light source provided by the light source module. The output image includes the output pixels, wherein each of the output pixels is composed of a plurality of second gray levels, and each of the second gray levels is the product of the first gray level and the corresponding brightness factor.

According to an embodiment of the present invention, the method for establishing the coordinate axis of histogram includes accumulating the number of the first gray levels having the same value, and using gray level as the abscissa of the coordinate axis of histogram and number of gray level as the ordinate of the coordinate axis of histogram.

According to an embodiment of the present invention, the adjustment factor (BACKDIM) satisfies

$$BACKDIM = A + \frac{apl}{{apl}_{max} / ( 1 - A )} , \qquad ( expression 1 )$$

wherein A is a constant between 0 and 1.

According to an embodiment of the present invention, the method for transforming each of the first brightness values into the second brightness value includes multiplying the first brightness value by the reciprocal of the adjustment factor and using the maximum gray level as the second brightness value if the product of the first brightness value and the reciprocal of the adjustment factor is greater than the maximum gray level. In addition, the method for transforming the original pixels into the output pixels includes multiplying each of the first gray levels by the brightness factor to obtain the second gray level.

According to an embodiment of the present invention, the method for transforming the first brightness values into the second brightness values includes determining the characteristic of the original image according to the medians of the first gray levels in the histogram and transforming the first brightness values into the second brightness values according to a specific relationship, wherein the specific relationship changes along with the characteristic of the original image. Different cases of the specific relationship are described below.

One case of the specific relationship includes: when the first brightness values are between 0 and a1, the second brightness values are a1; when the first brightness values are a1 to a2, the second brightness values are a1 to the maximum gray level, consequently, the second brightness values and the first brightness values are presented a linear relationship; and when the first brightness values are between a2 and the maximum gray level, the second brightness values are the maximum gray level, wherein 0<a1<a2<the maximum gray level.

Another case of the specific relationship includes: when the first brightness values are 0 to a1, the second brightness values are 0 to the maximum gray level, consequently a linear relationship is presented between the second brightness values and the first brightness values; and when the first brightness values are a1 to the maximum gray level, the second brightness values are the maximum gray level.

The specific relationship may also be: when the first brightness values are smaller than or equal to a1, the second brightness values are smaller than or equal to 192, and a first linear relationship is presented between the second brightness values and the first brightness value, wherein the slope of the first linear relationship is equal to the reciprocal of the adjustment factor; when the first brightness values are a1 to a2, the second brightness values are 192 to b1, and a second linear relationship is presented between the second brightness values and the first brightness values; when the first brightness values are a2 to a3, the second brightness values are b1 to b2, and a third linear relationship is presented between the second brightness values and the first brightness values; and when the first brightness values are a3 to 255, the second brightness values are b2 to 255, and a fourth linear relationship is presented between the second brightness values and the first brightness values. The slopes of the second linear relationship, the third linear relationship, and the fourth linear relationship are smaller than the reciprocal of the adjustment factor, wherein 0<a1<a2<a3<255 and 192<b1<b2<255.

In the present invention, a histogram is established based on the first gray levels of the original pixels of an original image, and an adjustment factor for adjusting the intensity of a light source provided by the light source module is established according to the histogram. Thereby, the intensity of the light source provided by the light source module can be modulated according to the characteristic of the original image and accordingly unnecessary electricity consumption is avoided. Moreover, in the present invention, the original pixels may be transformed into output pixels according to a specific relationship or according to the adjustment factor. Through the transformation of the output pixels and the adjustment in the intensity of the light source provided by the light source module, the image display method provided by the present invention can reduce the electricity consumption of a display apparatus without distorting the original image.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of an image display method according to an embodiment of the present invention.

FIG. 2 illustrates a histogram according to an embodiment of the present invention.

FIG. 3 illustrates a transformation relationship between first brightness values and second brightness values according to an embodiment of the present invention.

FIG. 4 illustrates a relationship between first brightness values and second brightness values when the medians fall within an area I of the histogram according to an embodiment of the present invention.

FIG. 5 illustrates a relationship between first brightness value and second brightness value when the medians fall within an area II of the histogram according to an embodiment of the present invention.

FIG. 6 illustrates a relationship between first brightness value and second brightness value when the medians fall within an area III of the histogram according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It can be understood from foregoing description of the conventional technique that by adjusting the light source in a liquid crystal display (LCD) to reduce the electricity consumption, an image displayed by the LCD may not be able to maintain its original contrast, namely, the image may be distorted. In order to resolve this problem, the present invention provides an image display method for a display apparatus. The display apparatus in the present invention has a light source module for providing a light source. In other words, the display apparatus in the present invention is a non-self-emissive display apparatus, such as a LCD.

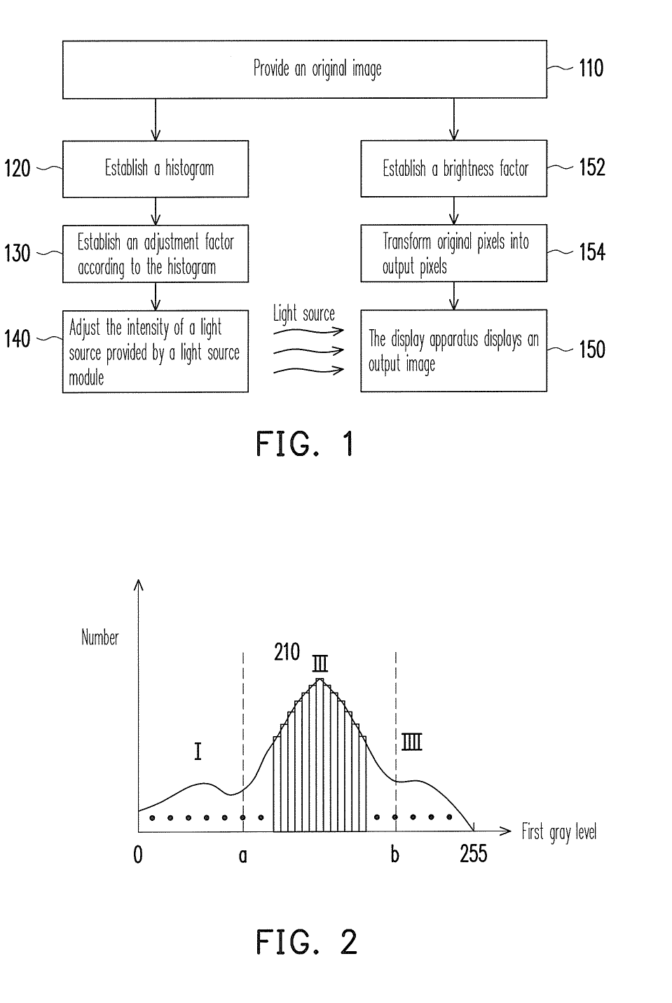

FIG. 1 is a flowchart of an image display method according to an embodiment of the present invention. Referring to FIG. 1, firstly, an original image is provided in step 110, wherein the original image is composed of a plurality of original pixels, and each of the original pixels is represented by a plurality of first gray levels. In the present embodiment, the original pixels may be small blocks presenting different colors, and an image (the original image) is composed of these colored blocks. In order to allow the original pixels, namely, the colored blocks, to present different colors, each of the original pixels is formed by red, green, and red color having different brightness respectively. Thus, the first gray levels may be the brightness values of the red, green, and blue color in RGB color coordinates.

Then, in step 120, a histogram is established according to the first gray levels and the number thereof. FIG. 2 illustrates a histogram according to an embodiment of the present invention. Referring to FIG. 2, the method for establishing the histogram includes accumulating the number of the same first gray levels, and using the first gray levels as the abscissa of the coordinate axis of histogram and the number of the first gray levels as the ordinate of the coordinate axis of histogram. The curve 210 shows exemplified the distribution of the first gray levels presented by the original pixels in the present embodiment.

In the present embodiment, the color depth are 8 bits, so the first gray levels of each pixel the display apparatus can display are 0 to 255; namely, there are totally 256 values, and the maximum gray level is 255. If the display apparatus has N pixels and each pixel is represented by three first gray levels, sufficient space for storing 256×3N data has to be designed in the display apparatus in order to establish the histogram. Thus, in other embodiments of the present invention, the histogram may also be established through stepping sampling so as to reduce the required storage space and simplify the calculation process.

For example, every 16 gray levels are considered in the same step while establishing the histogram and then the first gray levels in the same section are accumulated in the same storage position, so that the storage space of only (256/16)×3N data is needed to be reserved. However, in other designs, the histogram may also be established by grouping every 32 gray levels (or at other intervals) into a section. By establishing the histogram through phase-by-phase sampling, the image display method in the present embodiment is further simplified, and the required storage space and hardware cost are also reduced.

Referring to FIG. 1 again, after the histogram is established, an adjustment factor (BACKDIM) is established according to the histogram in step 130. To be specific, the method for establishing the adjustment factor (BACKDIM) includes following steps. First, one of the first gray levels is selected as a characteristic gray level (apl) from the histogram. Then, the adjustment factor (BACKDIM) is established according to a maximum gray level (aplₘₐₓ) of the display apparatus and the characteristic gray level (apl) through following expression:

$$BACKDIM = A + \frac{apl}{{apl}_{max} / ( 1 - A )} \qquad ( Expression 1 )$$

wherein A is a constant between 0 and 1.

In the present embodiment, when the color depth are 8 bits, and the maximum gray level of the display apparatus is 255, namely, the maximum value of the first gray levels is 255, and accordingly, aplₘₐₓ is 255 when the adjustment factor (BACKDIM) is established. However, when the maximum gray level which can be presented by the display apparatus has other values, the value of aplₘₐₓ changes along with this value of the maximum gray level, and the value 255 in the present embodiment is only taken as an example. In addition, the value of the constant A is actually determined by the light source module of the display apparatus. For example, the value of A may be the ratio of the least light brightness to the greatest light brightness which the light source module can provide. When the least light brightness is 0.5 times of the greatest light brightness of the light source module in a specific display apparatus, then the constant A used for adjusting the brightness of the image in this display apparatus has value 0.5.

Additionally, in an original image of the present embodiment, when the number of first gray levels for forming an original pixel is K, the characteristic gray level (apl) may be selected by sorting the first gray levels in an increasing order and selecting the (M%×K)^{th} first gray level as the characteristic gray level (apl). However, the characteristic gray level (apl) may also be selected by sorting the first gray levels in a decreasing order and then selecting the ((1−M%)×K)^{th} first gray level as the characteristic gray level (apl). Herein, M is a value predetermined by a designer and which is greater than 0 and smaller than 100. The adjustment factor (BACKDIM) can be calculated through foregoing expression 1 after the characteristic gray level (apl) is selected through foregoing method.

In step 140, the brightness of the light source provided by the light source module is adjusted according to the adjustment factor (BACKDIM). Accordingly, the planar light source provided by the light source module can be adjusted according to the brightness characteristic of the original image, and as a result, the electricity consumed by the light source module can be reduced. Substantially, when the adjustment factor (BACKDIM) is 0.6, in the present embodiment, the brightness of the light source provided by the light source module is adjusted to 0.6 times of its original brightness; however, herein 0.6 is only taken as an example. In addition, different adjustment factors (BACKDIM) is calculated regarding different original images. Thus, in the present embodiment, the brightness of the light source provided by the light source module can be adjusted regarding each image and accordingly the electricity consumption of the light source module can be minimized.

In step 150, the display apparatus displays an output image under the light source provided by the light source module. The light source provided by the light source module does not maintain its original brightness after being adjusted through foregoing method. At the same time, if the display apparatus displays the image according to the original pixels with different light source intensities, the image displayed by the display apparatus may present different contrasts as the original image. Thus, according to the present invention, besides adjusting the brightness of the light source provided by the light source module according to the characteristic of the original pixels, the original pixels are further transformed to allow the image presented by the display apparatus to appear closer to the original image.

The method for transforming the original pixels is illustrated in steps 152 and 154. First, in step 152, a brightness factor is established. In the present embodiment, the method for establishing the brightness factor may include transforming the first gray levels of each of the original pixels into a first brightness value and then transforming the first brightness value into a second brightness value to obtain the brightness factor, wherein the brightness factor is a ratio of the second brightness value to the first brightness value. It should be mentioned that in the present embodiment, the brightness factor changes along with the relationship between the first brightness value and the second brightness value; namely, the brightness factor does not have a fixed value.

In the present embodiment, the first gray levels may be transformed into the first brightness value by transforming the RGB color coordinates of the original pixels into the brightness value(Y) by a color coordinates of YUV. The method for transforming RGB color coordinates into YUV brightness color coordinates is a conventional technique and has many different calculation methods therefore will not be described herein.

After the brightness factors are established, in step 154, the original pixels are transformed into a plurality of output pixels according to the brightness factor. Through such a transformation, each of the output pixels may be represented by a plurality of second gray levels, and each of the second gray levels may be the product of the first gray level and the corresponding brightness factor. Namely, in the present embodiment, the original pixels are transformed into corresponding output pixels by using the brightness factors so that the reduced brightness of the light source provided by the light source module can be compensated.

To be specific, several methods for transforming the first brightness values into the second brightness values will be described below in order to explain the calculation method of the output image in the present invention. However, the method how the pixels are transformed is not limited in the present invention. Any method which allows an image presented by the display apparatus to maintain the contrast of the original image after the light source intensity is adjusted can be applied in the present invention.

Referring to FIG. 1, in step 152, each of the first brightness values is transformed into a second brightness value by multiplying the first brightness value by the reciprocal of the adjustment factor (1/BACKDIM) and using the maximum gray level as the second brightness value when the product of the first brightness value and the reciprocal of the adjustment factor (1/BACKDIM) is greater than the maximum gray level. Herein the original pixels are transformed into the output pixels by multiplying each of the first gray levels by the brightness factor to obtain the second gray levels.

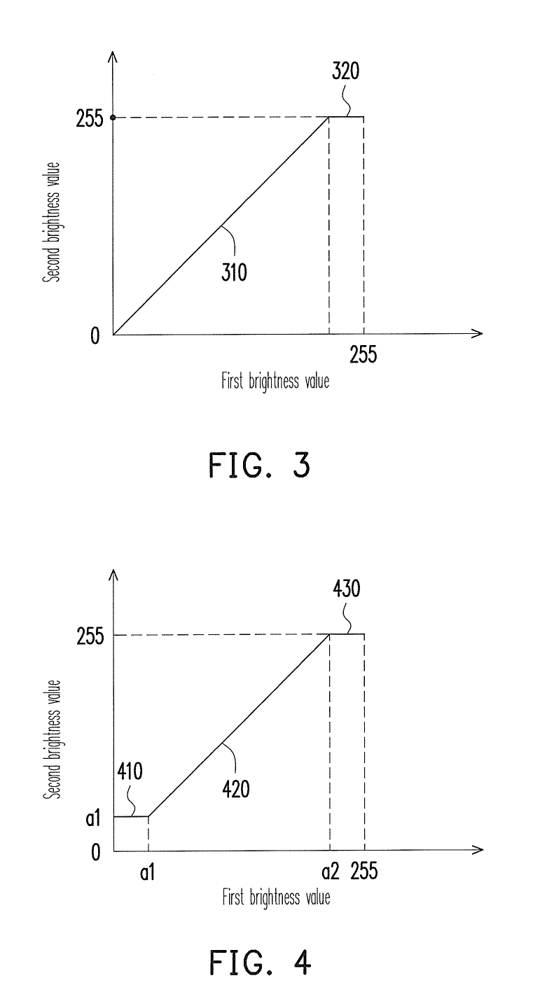

As described above, the first brightness values and the second brightness values present a transformation relationship as shown in FIG. 3, wherein the relationship between the two are as shown by the line segments 310 and 320. Referring to FIG. 3, the slope of the line segment 310 is the reciprocal of the adjustment factor, and when the product of each first brightness value and the reciprocal of the adjustment factor (1/BACKDIM) is greater than the maximum gray level, the maximum gray level is then served as the second brightness value; namely, the line segment 320 is a horizontal line segment. Additionally, in the present embodiment, the maximum gray level of the display apparatus is 255, and accordingly, the line segment 320 is substantially a horizontal line segment having the second brightness values as 255.

The original image is adjusted according to the relationship shown in FIG. 3 so that the intensity changes of the light source module can be compensated through the adjustment of the gray levels. Taking the original pixels having their first brightness values fall within the line segment 310 as an example, when the brightness of the light source module is reduced a specific proportion along with the adjustment factor BACKDIM, each output pixel of the output image is transformed according to 1/BACKDIM, and accordingly the reduced brightness of the light source module is compensated. Thus, the contrast presented by the image which is output eventually is close to the contrast presented by the original image. In other words, in the present embodiment, besides reducing the brightness of the light source provided by the light source module so as to reduce the power consumption, a good display quality is maintained in the display apparatus.

It should be mentioned that according to the results of the simulative calculations, if stepping sampling is adapted to establishing the histogram in the present invention, the difference between the eventually obtained output pixels and the original pixels remain within a tolerable error analysis range. Thus, the required storage space can be further reduced if stepping sampling is further adapted to establishing the histogram in the present embodiment.

Besides establishing the relationship between the first brightness values and the second brightness values by using the adjustment factor directly, in the present invention, the relationship between the first brightness values and the second brightness values may also be established according to the characteristic of the original image, and the original pixels may also be transformed to the output pixels according to the characteristic of the original image. As shown in FIG. 2, the characteristic of the original image may be determined by dividing the histogram into three areas I, II, and III according to the first gray levels 0˜a, a˜b, and b˜255, wherein a and b are respectively 32 and 192 but the present invention is not limited thereto.

Next, the characteristic of the original image is determined according to the median of the first gray levels in the histogram, as shown in FIG. 2. In statistics, a median is a value in a sample, a population, or a value in probability distribution, and a median can divide a sample value set (referred as value set) into two equal portions. Regarding a finite value set, all the values therein are sorted and the value in the middle is selected as the median. In other words, half of the values in a value set are smaller than the median and half of the values in the value set are greater than the median.

Herein, the first gray levels in the histogram form the value set, and the median in the present embodiment is the first gray level located in the middle of the value set. The first brightness values and the second brightness values satisfy following expressions when the median falls within the area I, II, or III. Namely, in the present embodiment, the method how to transform the first brightness values into the second brightness values can be determined according to the area in the histogram in which the median of the first gray levels is located.

When the median falls within the area I, the relationship between the first brightness values and the second brightness values is as shown in FIG. 4. Referring to FIG. 4, when the first brightness values are between 0 and a1, the second brightness values are identical to a1, as shown by the line segment 410. When the first brightness values are between a1 and a2, the second brightness values are between a1 and 255, and a linear relationship is presented between the second brightness values and the first brightness values, as shown by the line segment 420. When the first brightness values are between a2 and 255, the second brightness values are identical to 255, as shown by the line segment 430, wherein 0<a1<a2<255, and a1 may be 16. However, a1 may also have other values. In addition, the slope of the line segment 420 is equal to the reciprocal of the adjustment factor (1/BACKDIM).

In the histogram of the original image, it shows that the original image is actually a dimmer image if the median falls within area I. In order to allow the entire image to present a higher brightness, in the present embodiment, the brightness of those original pixels having their first brightness values between a1 and a2 are increased. In addition, a1 is used as the second brightness value of those original pixels having their first brightness values lower than a1, so as to prevent those dimmer portions of the original image from being distorted. The second brightness values of the original pixels in those brighter portions of the original image are made identical to 255.

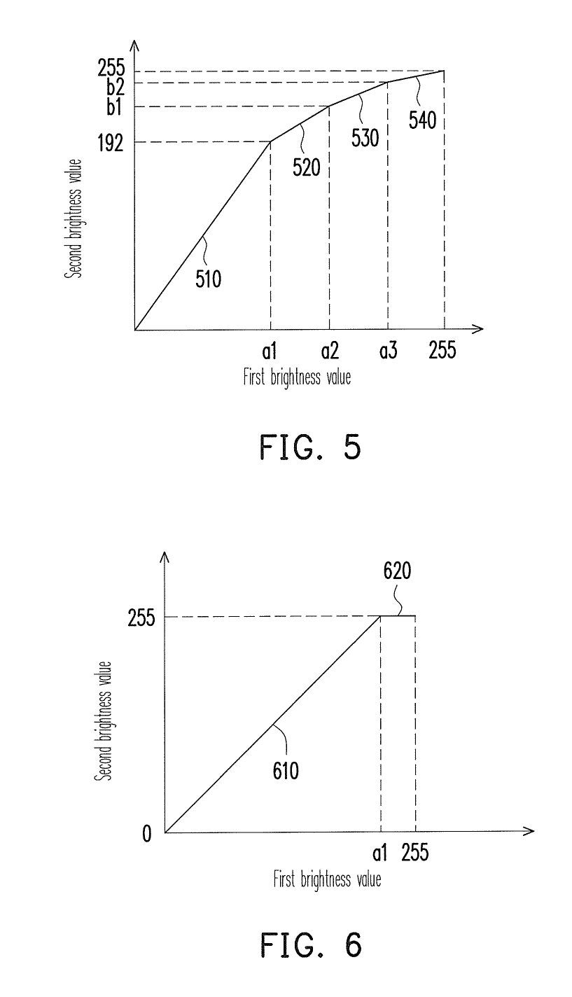

The original image belongs to a middle type when the median falls within the area II. In this case, the first brightness values and the second brightness values present a specific relationship as shown in FIG. 5. Referring to FIG. 5, when the first brightness values are smaller than or equal to a1, the second brightness values are smaller than or equal to 192, and a first linear relationship is presented between the second brightness values and the first brightness values, as shown by the line segment 510. The slope of the line segment 510 is equal to the reciprocal of the adjustment factor (1/BACKDIM). When the first brightness values are between a1 and a2, a second linear relationship is presented by the first brightness values and the second brightness values, as shown by the line segment 520. In this case, the second brightness values are between 192 and b1, and the second brightness values are in proportion to the first brightness values. Besides, when the first brightness values are between a2 and a3, the second brightness values are between b1 and b2, and a third linear relationship is presented by the second brightness values and the first brightness values, as shown by the line segment 530. When the first brightness values are between a3 and 255, the second brightness values are between b2 and 255, and a fourth linear relationship is presented by the second brightness values and the first brightness values, as shown by the line segment 540.

The slopes of the second linear relationship, the third linear relationship, and the fourth linear relationship are smaller than the reciprocal of the adjustment factor, wherein 0<a1<a2<a3<255 and 192<b1<b2<255. In other words, the slopes of the line segments 520, 530, and 540 are all smaller than the reciprocal of the adjustment factor (1/BACKDIM) for adjusting the light source module. To be specific, the slope of the line segment 510 is the reciprocal of the adjustment factor (1/BACKDIM), and accordingly a1 is the product of 192 and the reciprocal of the adjustment factor (1/BACKDIM) (i.e., a1=192×(1/BACKDIM)). In the present embodiment, the values of a2 and a3 are determined by expressions a2=(255−a1)×0.28+a1 (expression 2) and a3=(255−a1)×0.31+a2 (expression 3) respectively. Besides, the values of b1 and b2 are determined by expressions b3=255−(0.2×(255−a2)) (expression 4) and b2=b3−(0.48×(a2−a1)) (expression 5) respectively. However, in the present invention, the calculations of a2, a3, b1, and b2 are not limited to foregoing expressions. In other embodiments of the present invention, the first brightness values between a1 and 255 may also be converted into the second brightness values according to different linear relationships which satisfy other expressions and having their slopes smaller than 1/BACKDIM.

The entire image presented by the display apparatus is dimmed when the brightness of the light source provided by the light source module is reduced in order to save electricity consumption. In this case, a brighter original image may not be presented with a good contrast. Thus, in the present embodiment, a transformation method is adapted in order to allow the output image formed by the output pixels to appear closer to the original image.

Moreover, when the median falls within the area III, the specific relationship between the second brightness values and the first brightness values is as shown in FIG. 6. When the first brightness values are between 0 and a1, the second brightness values are between 0 and 255, as shown by the line segment 610. When the first brightness values are between a1 and 255, the second brightness values are identical to 255, as shown by the line segment 620. The original image is a brighter image when the median of the first brightness values falls within area III of the histogram. Regarding the brighter image, if the first brightness values of the original pixels are increased and then transformed into the second brightness values, those original pixels having greater first brightness values may be cut off. Thus, this type of images should not be adjusted according to relationships having great slopes. In the present embodiment, the value of a1 may be 245; namely, the brightness of the original pixels is only slightly adjusted in order to avoid distortion of the output image.

By adjusting the brightness of the light source provided by a light source module through the method described above, the electricity consumed by a display apparatus can be effectively reduced. Meanwhile, in the present invention, the first gray levels of a pixel are adjusted according to a specific relationship so that the image presented by the display apparatus can maintain their original contrast. Substantially, in the image display method provided by the present invention, when the light source provided by the light source module is dimmed to save electricity, the pixels of the original image can be transformed accordingly so that the image eventually presented by the display apparatus can be prevented from being distorted. Thereby, the image processing method provided by the present invention can reduce the power consumption of a light source module effectively, and at the same time, the image displaying method can maintain the quality of the original image in the output image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image display method for a display apparatus, wherein the display apparatus has a light source module for providing a light source, the image display method comprising:
providing an original image, wherein the original image comprises a plurality of original pixels, and each of the original pixels is represented by a plurality of first gray levels;
establishing a histogram according to the first gray levels and the number of the first gray levels;
selecting one of the first gray levels from the histogram as a characteristic gray level (apl);
establishing an adjustment factor (BACKDIM) according to a maximum gray level (aplₘₐₓ) of the display apparatus and the characteristic gray level (apl);
adjusting a brightness of the light source provided by the light source module according to the adjustment factor (BACKDIM);
transforming the first gray levels of each of the original pixels into a first brightness value, and transforming the first brightness value into a second brightness value to obtain a brightness factor, wherein the brightness factor is the ratio of the second brightness value to the first brightness value; and
transforming the original pixels into a plurality of output pixels according to the brightness factor such that the display apparatus displays an output image according to the output pixels with the light source provided by the light source module, wherein the output image comprises the output pixels, each of the output pixels is represented by a plurality of second gray levels, and each of the second gray levels is a product of the first gray level and the corresponding brightness factor.

2. The image display method according to claim 1, wherein the method for establishing the histogram comprises accumulating the numbers of the first gray levels having the same values and using gray level as the abscissa of the histogram and number of the first gray levels as the ordinate of the histogram.

3. The image display method according to claim 1, wherein the method for establishing the adjustment factor (BACKDIM) comprises allowing the maximum gray level (aplₘₐₓ) and the characteristic gray level (apl) to satisfy, wherein A is a constant
$$BACKDIM = A + \frac{apl}{{apl}_{max} / ( 1 - A )}$$
between 0 and 1.

4. The image display method according to claim 1, wherein the method for transforming each of the first brightness values into the second brightness value comprises multiplying the first brightness value by a reciprocal of the adjustment factor and using the maximum gray level as the second brightness value when the product of the first brightness value and the reciprocal of the adjustment factor is greater than the maximum gray level.

5. The image display method according to claim 1, wherein the method for transforming the first brightness values into the second brightness values comprises:
determining a characteristic of the original image according to the medians of the first gray levels in the histogram; and
transforming the first brightness values into the second brightness values according to a specific relationship, wherein the specific relationship changes along with the characteristic of the original image.

6. The image display method according to claim 5, wherein the specific relationship comprises:
the second brightness values being al when the first brightness values are 0 to a1;
the second brightness values being al to the maximum gray level, and the second brightness values and the first brightness values presenting a linear relationship when the first brightness values are a1 to a2; and
the second brightness values being the maximum gray level when the first brightness values are a2 to the maximum gray level, wherein 0<a1<a2<the maximum gray level.

7. The image display method according to claim 5, wherein the specific relationship comprises:
the second brightness values being 0 to the maximum gray level, and the second brightness values and the first brightness values presenting a linear relationship when the first brightness values are 0 to a1; and
the second brightness values being the maximum gray level when the first brightness values are a1 to the maximum gray level.

8. The image display method according to claim 5, wherein the specific relationship comprises:
the second brightness values being smaller than or equal to 192, and the second brightness values and the first brightness values presenting a first linear relationship when the first brightness values are smaller than or equal to a1, wherein the slope of the first linear relationship is equal to a reciprocal of the adjustment factor;
the second brightness values being 192 to b1, and the second brightness values and the first brightness values presenting a second linear relationship when the first brightness values are a1 to a2;
the second brightness values being b1 to b2 and the second brightness values and the first brightness values presenting a third linear relationship when the first brightness values are a2 to a3; and
the second brightness values being b2 to the maximum gray level, and the second brightness values and the first brightness values presenting a fourth linear relationship when the first brightness values are a3 to the maximum gray level, wherein the slopes of the second linear relationship, the third linear relationship, and the fourth linear relationship are smaller than a reciprocal of the adjustment factor, 0<a1<a2<a3<the maximum gray level, and 195<b1<b2<the maximum gray level.
